(19) United States
(12) Patent Application Publication
(10) Pub. No.: US 2026/0259310 A1
(43) Pub. Date: Sep. 3, 2026

(54) RADAR SENSING USING ADAPTIVE PHASE-CHANGING DEVICES (APDS)

(71) Applicant: Google LLC, Mountain View, CA (US)

(72) Inventors: Jibing WANG, Mountain View, CA (US); Erik STAUFFER, Mountain View, CA (US)

(21) Appl. No.: 19/162,241

(22) PCT Filed: Feb. 23, 2024
(86) PCT No.: PCT/US2024/017050

§ 371 Date: Sep. 4, 2025

Related U.S. Application Data
(60) Provisional application No. 63/492,615, filed on Mar. 28, 2023.

(51) Int. Cl. G01S 13/46; G01S 7/00

(52) U.S. Cl. CPC G01S 13/46; G01S 7/006; G01S 2013/464

(57) ABSTRACT

This disclosure provides devices, methods, and systems for radar sensing using adaptive phase-changing devices (APDs). An example device (e.g., a base station, a user equipment, a satellite network entity, etc.) first transmits (340) initial radar signals in multiple directions to identify a blocking object. Based on the identified position of the blocking object, the device may employ (366) an APD (e.g., based on its registered position) that helps routing signals around the at least one blocking object (such as an APD positioned to reflect the radio waves from the device to reach behind the blocking object). The device has the APD vary (377) phase vectors to change reflection directions of APD radar sensing signals to scan for a blocked object blocked by the blocking object. When the device finds a blocked object, the device determines (386) a set of APD configurations for a signal path specific to the blocked object.

### CROSS-REFERENCE TO RELATED APPLICATION

This application claims the benefit of and priority to U.S. Provisional Application Ser. No. 63/492,615, entitled “RADAR SENSING USING ADAPTIVE PHASE-CHANGING DEVICES (APDS),” filed on Mar. 28, 2023, the disclosures of which are incorporated herein by reference in the entirety.

### FIELD

The present disclosure relates generally to location sensing related to wireless communications.

### BACKGROUND

Radio detection and ranging (radar) uses electromagnetic waves to determine the distance and velocity of objects, which can reveal an object's position. A radar system or device often includes a transmitter producing electromagnetic waves, a transmitting antenna, a receiving antenna, a receiver, and a processor to determine the properties (e.g., distance, velocity, etc.) of objects. The radar system or device may use time of flight (e.g., traveling time between transmission from the transmitting antenna and reception at the receiving antenna) or frequency-modulated continuous-wave changes (e.g., changes in phases of the radio waves) to determine the properties.

Modern wireless communication devices use radio waves for telecommunication. These wireless devices can use the same radio waves for radar ranging and sensing to determine locations of other wireless devices (e.g., for transmitting radio beams in specific directions to improve signal strengths). Such wireless devices often face obstacles or blockages that hinder or prohibit radar ranging and sensing from detecting the location of a compatible wireless communication device.

### SUMMARY

The present disclosure provides methods, systems, and techniques for acquiring obstacle information for routing signal paths around those obstacles during wireless communications with a compatible communication device. High-frequency radio waves, such as those used in the 5^{th} generation (5G) communications and beyond, are subject to signal blockage or degradation by various stationary or moving obstacles (e.g., walls, windows, water vapor, human bodies, etc.). A network entity (e.g., a base station (BS)) might perform beamforming (e.g., changing directional properties of transmission and reception beams) to identify a signal path with the best signal to noise ratio (SNR). Without obstacles, such signal path is usually the line of sight (e.g., a straight line between two points in space).

When the line of sight is blocked, however, the network entity may take advantage of an adaptive phase-changing device (APD) to alter (e.g., by reflection) the beam direction and route the signal path around the obstacle. Such APD includes a reconfigurable intelligent surface (RIS), also called an intelligent reflecting surface (IRS), and a wireless control module. The APD includes multiple configurable antenna elements that are capable of altering signal reflection directions by changing respective phases of the antenna elements.

According to aspects of this disclosure, a network entity trains the APD to assist in radar ranging (or joint radar-and-communication signaling). The APD, or another entity such as a server, provides the APD's location or position information to the network entity so that the network entity may select the APD. The training of the APD includes varying the APD in various possible configurations (e.g., testing different beam directions at the network entity and reflected angles by the APD) to identify a signal path that routes around known obstacles. For example, the network entity uses radar signals and detects reflections of the radar signals, if any, to ascertain APD configurations that route signals around the obstacle and potentially for receipt by a compatible wireless communication device.

The radar signal reflections from a blocked/unknown object indicate that the APD as tentatively configured has reflected the radar sensing signals behind the obstacle. This APD configuration establishes a signal path and allows the network entity to further investigate (e.g., attempting to communicate with the blocked object using a reflected signal rather than a line of sight signal). The network entity may perform such training without knowledge of obstacle information in the surroundings (e.g., behind known obstacles when APD is used), resulting in saving significant resource expenditure (e.g., without requiring feedback signaling from the UE). In this disclosure, a “blocked object” refers to an unknown object blocked by obstacles such that a seeker may not reach the blocked object with line-of-sight signals. A blocked object may include a UE device capable of communication and non-UE objects(e.g., any object that reflects radar sensing signals).

According to aspects of the example method, the device first transmits initial radar signals in multiple directions to identify a blocking object (or multiple blocking objects). For example, upon receiving a reflection of at least part of the radar signals, the device identifies, using various radar sensing techniques, at least one blocking object position of at least one blocking object. Based on the identified position of the at least one blocking object, the device selects an APD positioned to reflect the radio waves from the device to reach behind the blocking object. In some cases, the device stores pre-registered positions of multiple APDs. The device also has control over the APDs.

The device then transmits radar signals in a refined direction toward the APD. The device controls the APD to produce multiple APD radar signals in various directions. The multiple APD radar signals in various directions enable the device to detect a blocked object behind the blocking object. When the blocked object reflects the radar signal back to the APD and reaches the device, the device ascertains a set of configuration parameters of a radio transmission path via the APD. For example, the set of configuration parameters of the radio transmission path may include parameters of the device to transmit in the refined direction, the phase-changing configurations of the APD, and other ranging or movement properties of the blocked object.

In general, the radar sensing and communication signaling device may be implemented in a base station (e.g., as a monostatic radar system), a non-terrestrial network entity, a (mobile) UE, or any wireless devices capable of performing radar sensing and telecommunications. A blocking object reflects, attenuates, or interferes with radio signals passing by. The blocked object may include any object behind the blocking objects that are initially identified by radar sensing. The blocked object may include (but not require) a wireless device capable of signaling with the device, because the present disclosure provides various techniques for determining the configuration parameters of the signal path via an APD without requiring active signals transmitted by the blocked object (i.e., the return of the radar signals is passive).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments. Like reference numerals indicate like elements.

FIG. 1 is a diagram depicting a first example environment for radar sensing using adaptive phase-changing devices (APDs) to overcome at least one obstacle, according to some embodiments;

FIG. 2 is a diagram depicting a second example environment for radar sensing using APDs to overcome two or more obstacles, according to some embodiments;

FIG. 3 is a signaling diagram depicting a first example method of radar sensing using APDs to overcome at least one obstacle, according to some embodiments;

FIG. 4 is a signaling diagram depicting a second example method of radar sensing using APDs to overcome two or more obstacles, according to some embodiments;

FIG. 5 is a flow diagram depicting an example method for radar sensing using APDs, according to some embodiments;

FIG. 6 is a flow diagram depicting an example method for radar sensing using APDs, according to some embodiments; and

FIG. 7 is a block diagram depicting an example device diagram of a device to perform radar sensing using APDs, according to some embodiments.

### DETAILED DESCRIPTION

Wireless devices, such as a base station (BS), a user equipment (UE), or the like (e.g., non-terrestrial network entities), may use radio waves for both communication signaling and location sensing, known as joint communication and radar sensing. Joint communication and radar sensing uses millimeter waves consistent with Fifth Generation (5G) New Radio (NR) standards and beyond, such that the two functions may employ the same set of hardware (e.g., transmitters, receivers, processors, etc.) while implemented with respective software (e.g., by using software defined radios). For example, when the wireless devices use massive multi-input-multi-output (MIMO) and/or beamforming (e.g., using directional and narrow radio beams), the wireless devices may use common spatial access principles for both the communication and the radar systems.

The ability of radar sensing may provide advantages in various communication applications, including beamforming, vehicle to everything (V2X) location sensing, among others. Radar sensing includes transmitting radio waves and analyzing echoes of the radio waves, if any, to determine properties of objects (here, obstacles, blockers, or another wireless device). The properties may include distance (or ranging), direction, and moving speeds of the objects. A radar device (integrated in the wireless device as aforementioned) may include a monostatic radar that has a receiver co-located with a transmitter, or a bistatic radar that has a transmitter and receiver separated by a distance. In either configuration, the radar device may use non-continuous waves (in time-of-flight) or continuous waves (including frequency modulations).

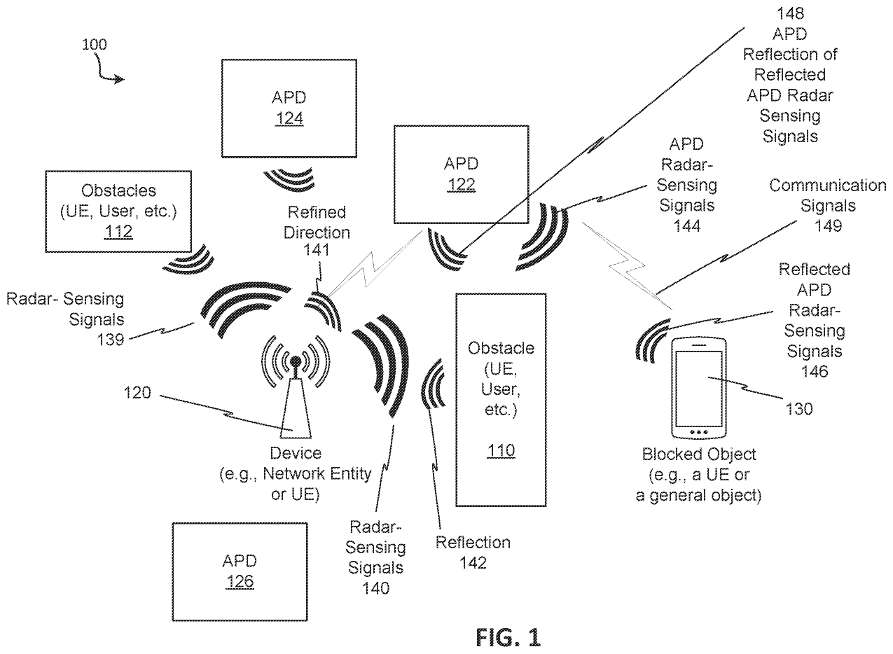

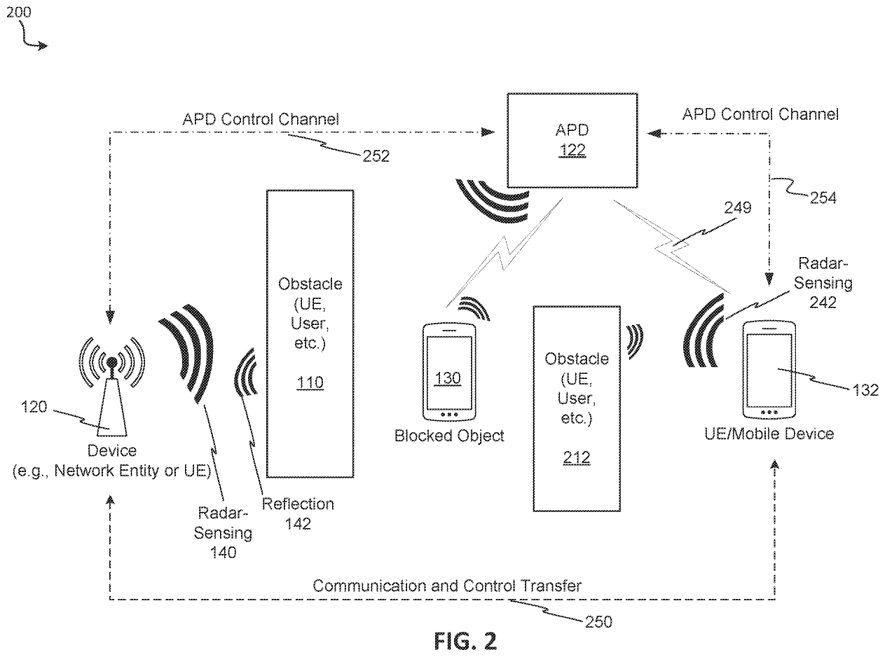

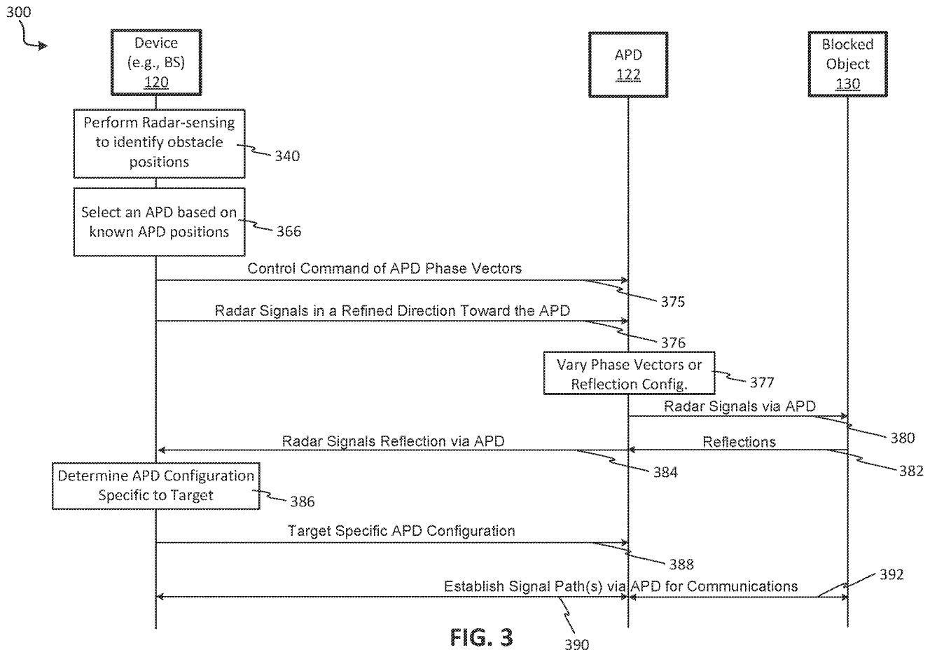

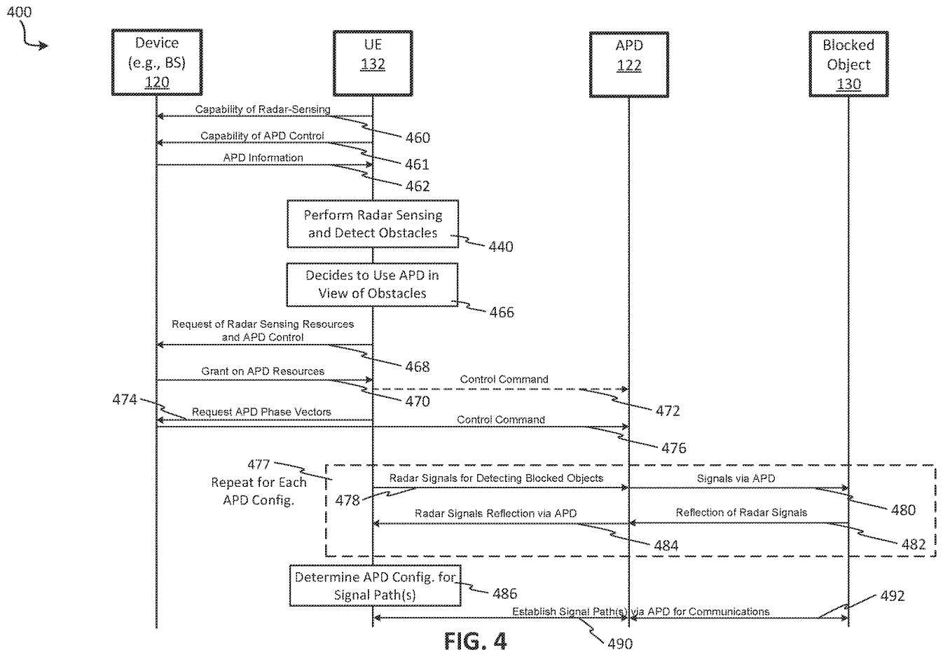

In joint communication and radar sensing, a wireless device exploits cooperative or joint use of spatio-temporal resources for both communication links and radar sensing echoes. For example, the signal beams formed by antenna arrays or panels may perform both downlink/uplink communication as well as perform signal processing for radar detections. In some cases, together with communications with one or more compatible communication devices, the wireless device may also perform bistatic radar sensing (e.g., using one of the compatible communication devices as a receiver for radar sensing signals). In some cases, the wireless device may perform mixed monostatic and bistatic sensing for vehicle-to-vehicle (V2V) or vehicle-to-everything (V2X) communications and radar sensing. Although the following discussion uses monostatic radar sensing as examples (e.g., in FIGS. 1 and 3), someone having ordinary skills in the art would understand that the examples may also use bistatic radar sensing (e.g., in FIGS. 2 and 4).

In either case, a conventional wireless device often requires line-of-sight reflections (sometimes called “echoes”) to achieve radar sensing. That is, if a blocked object (e.g., a device in an established communication) is mobile and moves behind a blocker, the communications will become terminated and radar sensing would not identify an updated location of the blocked object because the blocker blocks radar sensing waves as well. The present disclosure addresses such issues by using one or more adaptive phase-changing devices (APDs) to reflect radar sensing waves around the blocker to obtain an updated location of the blocked device without requiring return communication signals from the device. After the wireless device obtains the updated location of the mobile communication device, the wireless device may identify (e.g., while using the APDs to route around the blocker) new communication beams/channels with the blocked device quickly and efficiently based on the updated location. Because the joint communication and radar sensing uses high frequency radio waves that are subject to blockage, the disclosure focuses on using an APD to enable routing around obstacles.

APDs include reconfigurable intelligent surfaces (RIS), also called intelligent reflecting surfaces (IRS), which include multiple antenna elements tunable to interact with electromagnetic waves (passively or actively). For example, a passive RIS may include an array of subwavelength-sized of antenna elements having properties such as reflection, negative refraction, absorption, or scattering, among others. A RIS controller applies or configures phase vectors of the RIS elements to alter the reflective properties (e.g., varying output directions of radio wave reflections). In some cases, the configuration of RIS elements uses similar principles as beamforming (using the antenna elements to control the direction of a wave-front by weighting the magnitude and/or phase). As such, even when a device and an APD maintain relatively constant positions with each other, the device can configure the APD to generate reflective beams in various directions by controlling the phase vectors and other configuration aspects at the APDs. Although the examples below use phase vectors as a general term to discuss controlling APDs, someone having ordinary skills in the art would understand that various parameters of various aspects of APDs may also be controlled or adjusted according to specific circumstances. In some examples, APDs and RIS are interchangeable terms.

The present disclosure provides example devices, systems, and methods for identifying radio transmission signal paths using radar sensing with APD assistance, to address issues related to the blockage of high frequency radio waves. For example, when the device expects to communicate with a compatible communication device behind a blocking object, the device may perform location sensing using radar before attempting communication signaling. The device may use the disclosed method either to learn about the obstacle environment so as to make better beamforming decisions, or to seek an updated location of a known device having moved behind an obstacle, or experiencing blockage due to a moving obstacle intervening, among other use cases.

Radar sensing using APDs poses multiple challenges. First, when the network entity has access to multiple APDs positioned in various locations, the network entity may not know how to select particular APD(s) to route around specific yet unknown obstacles. Second, the network entity seeks to configure the incident and reflection angles of the particular APD(s) to reach a (likely moving) blocked object blocked by the obstacles. For purposes of radar sensing, the moving blocked object may be either: a UE or a device capable of communication with the network entity; or an object incapable of communication with the network entity. Third, the network entity should perform these operations in a resource efficient manner. The present disclosure provides methods and techniques for addressing these challenges. For example, the present disclosure addresses obstacle identification and APD configuration inefficiencies by having the network entity perform radar sensing to estimate obstacle positions and narrow down available signal directions to route the signal path around the obstacles. This way, the network entity may better select an APD from multiple available APDs to reach a UE device.

For example, a wireless communication device that controls an APD may identify a radio transmission signal path around obstacles by first transmitting radar signals in various directions to identify at least one blocking object position of at least one blocking object, based on reflection of the radar signals. After identifying the at least one blocking object position, the device selects one or more available APDs to ascertain a signal path to reach a blocked object behind the at least one blocking object. The hardware of the wireless communication device (generally “device”) used for radar sensing also performs communication signaling. In general, the device described herein may be a network entity or a UE device. The following describes the device at a high level and provides examples directed to specific situations when the device is a network entity and when the device is a UE device.

During operation, the device first performs preliminary radar sensing without using any APD and detects at least one blocking object position (when the device detects no blocking object, the device would operate using line-of-sight joint-radar-communication-signaling without involving APDs). Based on the results of the preliminary radar sensing, the device models its surrounding with the at least one blocking object (e.g., size, direction, and distance relative to the device).

Second, the device uses the relative positions of: (1) the device, (2) APDs whose positions are registered with the device, and (3) the position of the at least one blocking object detected based on preliminary radar sensing to select, from one or more deployed APDs, an APD that could geometrically enable routing of a signal from the device around the at least one blocking object (e.g., the geometry constraint depending on how much an APD may alter a signal direction). For example, the device selects an APD that is geometrically capable of reflecting a signal path around the blocking object (i.e., the reflection path circumventing the blocking object).

When multiple APDs are available, the device may store registrations of the respective positions of the multiple APDs. The registrations may include an initial registration, an updated registration, or both. The initial or updated registration information may include the initial or updated positions (e.g., adjustable) as well as the supported reflection configurations of the APDs. The device may select an APD that provides a good coverage (e.g., range, distance, or signal strength) behind the at least on blocking object. When two or more APDs provide optional signal paths circumventing the blocking object, the device may select one based on rules or user preferences (e.g., random selection, selection in turn, user indication, etc.).

Third, upon selecting an APD, the device transmits radar signals in a refined direction toward the APD. The refined direction avoids the at least one blocking object. The device can thus transmit radar signals around the blocking object and use the APD to reflect the radar signals to go about or circumvent the at least one blocking object. Using control signals to the APD, the device varies a reflection configuration of the APD to produce APD radar signals in multiple directions. At least some of the APD radar signals in the multiple directions may reach the blocked object behind the at least one blocking object.

When the device configures the APD to change the angles of reflections of the APD radar signals, the device may initiate the change of the angles by detecting either an expiration of a timer corresponding to a radar sensing range or by detecting a reflection from the blocked object via the APD. Upon detecting the expiration or reflection, the device may update the APD configuration to change the radar signal reflections in a next one of the multiple directions. Because the same signal path formed with the APD may apply to both radar sensing and signal communications, the device may obtain a set of configuration parameters for a (future) radio transmission signal path via the APD for wireless communications with the blocked object (when the blocked object is capable of signaling with the device). The set of configuration parameters corresponds to one of the multiple directions of the APD radar signals.

In some cases, the APD may use a set of default configuration parameters if the device does not detect a radar sensing reflection of the APD radar signals (e.g., indicating that the device has not detected a blocked object behind the at least one blocking object). In some cases, the device detects multiple blocked objects. The device may then configure the APD (by applying a set of corresponding configuration parameters for each of the multiple blocked objects) to direct radar sensing signals to one of the multiple blocked objects (or to all of the multiple blocked objects in turn) based on certain criteria (e.g., distance from the APD, movement speeds, etc.). For example, the device may prioritize performing radar sensing on a blocked object that is the closest, among the multiple blocked objects, to the APD.

The device may use a transmitter and a receiver for monostatic radar sensing. The radar transmitter and the radar receiver may be in common with existing transmitters and receivers for signal communications or may be a dedicated transmitter/receiver for radar sensing. For example, when the device is a network entity (e.g., a terrestrial or non-terrestrial network (NTN) base station (BS)), the device may have dedicated transmitters and receivers (e.g., a monostatic radar) for radar sensing. In other cases, the device may also use a common set of transmitter and receiver for simultaneous network communications and radar sensing (sometimes known as joint communication radar sensing). Similarly, when the device is a mobile UE device (e.g., a smartphone) or a battery-powered NTN base station, the device may use the same transmitter and receiver for both signal communications and monostatic radar sensing. Such a device may alternatively have a dedicated set of transmitter and receiver for radar sensing.

When the device varies the reflection configurations of the APD, the device may transmit to the APD various sets of configuration parameters corresponding to different antenna element phases to vary the reflection configuration of the APD (e.g., when the APD is a passive RIS). The set of configuration parameters may be based on the fixed location of the network entity, the at least one blocking object position, and the position of the APD.

To have the APD reflect incident radar signals in the refined direction to create APD radar signals in multiple directions, the device transmits the various sets of configuration parameters to the APD one-by-one. For example, the device transmits a first set of configuration parameters, waits until a completion of detection or radar sensing of the blocked object (e.g., based on reflection or timer expiration), and then transmits a next set of configuration parameters. In some cases, the device may transmit the sets of configuration parameters regardless of the result of radar sensing at each set, to gather a broad range of available data for analysis. In some cases, the device may save transmitting subsequent sets of configuration parameters when the device has successfully detected the blocked object (e.g., reflection signals exceeding a threshold value).

When the device is a network entity and after the device has established a wireless communication with the blocked object behind the blocking object, the device may grant the blocked object control of the APD. The blocked object may be a UE device and use the principle of reciprocity to transmit signals to the device, where the APD uses the same configuration to provide the signal path identified by radar sensing to support the reverse signal path. The blocked object in control of the APD may then perform radar sensing to further identify obstacles in its surroundings and other blocked objects reachable with the help of the APD based on reflections of the APD radar signals.

When the device is a UE device already in wireless communications with a network entity that has initial control of the APD, the UE device may transmit a message to the network entity indicating its radar sensing capability. The UE device may receive APD registration information from the network entity (e.g., responsive to the radar sensing capability of the UE device). The UE device may first perform sensing with its own radar sensing system to seek the blocked object. When the UE device fails to detect the blocked object (e.g., blocked by obstacles identified by the radar sensing system of the UE device), the UE device may then request control of the APD (e.g., among multiple APDs registered at the network entity) and use the APD to find a signal path around the obstacles. That is, the signal path relies on a particular configuration of the APD associated with a reflection angle.

When the device has identified or determined an APD configuration that provides a signal path for radar sensing, the device may transmit other signals (e.g., physical random access channel, channel state information reference signals, sounding reference signals, and/or procedures for initiating communication) toward the blocked object via the APD that reflects communication signals like the radar sensing signals under same or similar configurations. The signal path of joint radar-sensing and communication enable communications between the device and the blocked object. For example, when the blocked object is a UE, the UE may transmit an initial access request to the device using the signal path provided by the APD, as discussed in relation to FIG. 1 below.

FIG. 1 is a diagram depicting a first example environment 100 for radar sensing using adaptive phase-changing devices (APDs) to overcome at least one obstacle, according to some embodiments. As shown, multiple obstacles 110 and 112 surround the device 120. The device 120 may use one or more of the APDs 122, 124, and 126 to route radio waves around the obstacles 110 and 112 under certain circumstances. A blocked object 130, being behind the obstacle 110, is out of line-of-sight from the device 120. As further discussed below, the device 120 may use the APD 122 to perform radar sensing behind the obstacle 110, obtain a set of configuration parameters of a reflected radio transmission signal path to reach the blocked object 130, and establish communication.

In some cases, the device 120 may transmit the radar sensing signals 140 in a first general direction (e.g., to the right as illustrated, or to one side of the surrounding). The first general direction depends on existing antenna configurations of the device 120. Using the existing antenna configurations, the device 120 may ignore the space or areas not covered by the radar sensing signals 140. In some examples, the device 120 may include another antenna panel (or change the configuration) to transmit radar sensing signals 139 to a second general direction (e.g., toward the obstacle 112).

In addition to performing radar sensing, the device 120 may receive a map of known/permanent obstacles (e.g., a building plan and/or an elevation map including walls/windows/doors, or fixtures in an indoor mapping situation). The device 120 may then direct the radar sensing signals 140 to verify or align the map with the obstacles detected by radar sensing. In some cases, the device 120 may discover obstacles in the environment based on movement of the blocked object, such as by transmitting the radar sensing signals 140 toward a general area that the blocked object may travel into.

In one embodiment, the device 120 is a base station (or any stationary network entity). The device 120 has radar sensing capability. The device 120 has access to control the APD 122, such as, e.g., via control channels during radar sensing. Before selecting the APD 122, the device 120 first performs a general radar sensing operation to detect surrounding obstacles, e.g., by transmitting radar sensing signals 140 in various (general) directions. Based on the general radar sensing results, the device 120 computes/creates/generates a low-precision map about the detected obstacle 110. By detecting or measuring the reflection 142 of the radar sensing signals 140, the device 120 determines the distance, direction, and other properties (such as span or coverage area) of the obstacle 110.

The device 120 then selects, from the APDs 122, 124, and 126, an APD that is capable of reflecting radio waves from the device 120 to circumvent the obstacle 110. The device 120 selects the APD based on geometric relationships of the relative positions of the device 120 itself, the positions of the APDs 122, 124, and 126, and the position of the obstacle 110. The device 120 accesses the locations/positions of the APDs 122, 124, 126 registered or updated by the respective APDs. Because the locations of the device 120 and the APDs 122, 124, and 126 are relatively constant in this example, the respective incoming angles of radio waves from the device 120 to the APDs 122, 124, or 126 are also relatively constant.

Given the stable angles of incidence, each of the APDs 122, 124, and 126 may achieve a range of reflection of the radar sensing signals by changing respective physical orientations of the APDs 122, 124 and 126, and/or changing phase shift parameters of the respective antenna arrays to alter reflection directions. The device 120 may then determine, based on the respective range of reflection by each APD, which APD is capable of sending the radar sensing radio wave reflections behind the obstacle 110. As shown in FIG. 1, because the APDs 124 and 126 are positioned to the left of the obstacle 110, the reflected radio signals from the device 120 and off the APDs 124 or 126 would still be blocked by the obstacle 110 (e.g., the APDs 124 and 126 cannot geometrically provide a feasible signal path to reach space to the right of the obstacle 110). In the illustrated example in FIG. 1, the APD 122 provides a geometrically feasible signal path by reflecting the radar sensing signals 140 around the obstacle 110.

Upon selecting the APD 122 for routing around the obstacle 110, the device 120 decides on the phases of the APD 122 based on its location and an expected location of the blocked object 130 (e.g., generally behind the obstacle 110 or a predicted location based on previously known positions and/or movement speeds of the blocked object 130). Because the blocked object 130 is not in line-of-sight with the device 120, the device 120 uses the APD 122 to reflect the radio waves between the device 120 and the blocked object 130.

In some cases, the device 120 may have access to a high-precision spatial map of the obstacle 110 (as well as other obstacles in the surroundings) and possible positions of the blocked object (e.g., chairs, people, UEs, etc.). The device 120 uses the high-precision spatial map in addition to or in the place of initial radar sensing, which if performed, helps the device 120 align the high-precision map. When the high-precision spatial map is not available, the device 120 performs initial radar sensing to compute or create a low-precision spatial map (and may further perform detection operations by producing beams from the APD 122 in different directions to determine the reflection configuration of the APD 122, as discussed below).

Using either the high-precision or the low-precision spatial map, the device 120 may computationally determine the APD 122 phase parameters (e.g., phase vectors), which configure the APD 122 to reflect both the APD radar sensing signals 144/148 and potential communication signals 149 to and from the blocked object 130. For example, after the device 120 determines the reflection configuration of the APD 122, the device 120 may conduct initial access procedures (e.g., providing parameters for a RACH process), by signaling with the blocked object 130 via the APD 122, to establish communication with the blocked object 130 when the blocked object 130 is a UE.

In some cases, the device 120 does not have access to the high-precision spatial map and needs to determine a configuration for the APD 122. For example, the device 120 changes the APD phases and generates different sweeping beams/radio waves in different directions behind the obstacle 110. In some cases, the device 120 configures the APD 122 to reflect the APD radar sensing signals 144 in a first direction (of multiple candidate directions in one sweep). The device 120 then transmits the radar sensing signals 141 at the refined direction toward the APD 122 and waits for a reflection of the APD radar sensing signal 146, 148 to return from the blocked object 130. In some cases, the device 120 communicates with the APD 122 regarding the APD phase sweeping pattern. For example, the device 120 sends the APD 122 a series of phases and notifies the APD 122 when to apply each of the series of phases. This way, the device 120 may align its radar transmission/reception processing with the APD phase sweeping to detect the blocked object 130 within an estimated phase reflection time.

When the APD radar sensing signals 144 miss the blocked object 130 and upon an expiration of a timer (e.g., the timer limit corresponding to a detectable distance behind the obstacle 110), the device 120 configures the APD 122 to reflect the APD radar sensing signals 144 in a next direction of the multiple candidate directions in the sweep, until the device 120 receives the reflected APD radar sensing signals 146, 148. If the device 120 has attempted various configurations for the APD 122 and does not receive the reflected APD radar sensing signals 146, 148 (e.g., because timers for each configuration have expired), the device 120 may set the APD 122 to default configurations and completes the radar sensing attempt. If the device 120 receives the APD reflection 148 of the reflected APD radar sensing signals from the APD 122, the device 120 then performs processing on the received reflected radar signals 148 to determine properties of the blocked object 130.

In some cases, multiple blocked objects (not shown) may be behind the obstacle 110. The device 120 may complete a sweeping cycle to obtain the respective properties (e.g., distance, direction, movement speeds, etc.) of the detected objects and treat them as candidates for the blocked object 130 (and determine, if the blocked object 130 is a wireless device, which candidate is the blocked object 130 by establishing communications by a RACH process).

FIG. 2 is a diagram depicting a second example environment 200 for radar sensing using APDs to overcome two or more obstacles 110 and 212, according to some embodiments. In the example environment 200, the obstacle 110 prevents the device 120 from performing radar sensing via the APD 122 to discover the blocked object 130 behind the obstacle 110. For example, the device 120 cannot have radar sensing signals (or other signals) reach the APD 122 due to the blockage by the obstacle 110 even if the device 120 is communication with the APD 122 (e.g., via other forms of wireless communications not subject to the blockage, or via landlines). In addition to being in communication with the APD 122, the device 120 is in communication with a mobile device 132 (or a second UE) positioned behind the obstacle 110. FIG. 2 shows how the mobile device 132 performs radar sensing and communicates with the blocked object 130, with access to the APD 122 granted from the device 120.

For example, the mobile device 132 performs radar sensing 242 (similar to the device 120 performing radar sensing in FIG. 1) and detects properties (e.g., distance, direction, dimensions/shapes, and/or relative movements) of the obstacle 212, which blocks the line-of-sight to the blocked object 130. Because the device 120 is in communication with the mobile device 132 and the APD 122, the device 120 knows the positions and capabilities (as reported or registered) of the mobile device 132 and the APD 122 and determines that the mobile device 132 may perform radar sensing with the assistance of the APD 122. The device 120 then transfers (via the connection 250) control of the APD 122 to the mobile device 132. The mobile device 132 then sends commands to the APD 122 via the APD control channel 254 to align the APD phase vectors with the radar sensing processing on the mobile device side 132.

Similar to discussions with regard to FIG. 1, the mobile device 132 may receive location/position/orientation information of the APD 122 and use it to determine the APD phase vectors (determined based on the position of the mobile device 132 as well as the properties of the obstacle 212) to circumvent the obstacle 212. Upon configuring the APD phase vectors using radar sensing 242, the mobile device 132 may initiate initial access procedures with the blocked object 130 (such as sidelink communications or as a proxy for the device 120 for downlink or uplink synchronizations) to establish signaling communications 249. In some cases, the blocked object 130 may move into “dead areas” that neither the device 120 nor the mobile device 132 may reach with the help of the APD 122. In this situation, the device 120 may record the “dead areas” information for future reference and terminate the existing radar sensing attempt.

In some cases, similar to the radar sensing procedures with APD assistance in FIG. 1, the mobile device 132 performs radar sensing by evaluating a series of phase vectors for the APD 122. The mobile device 132 may control the series of phase vectors via the APD control channel 254 directly or through the APD control channel 252 via the device 120 (using the connection 250). In the first case where the mobile device 132 directly controls the APD 122 via the APD control channel 254, the device 120 may configure (via the connection 250) the APD control resource at the mobile device 132. For example, the APD control resource may include the time resource on when the APD can be used to reflect radar sensing waveforms/signals from the mobile device 132. In the second case, the device 120 uses an existing control access via the APD control channel 252, similar to that in FIG. 1.

As shown in FIG. 2, the mobile device 132 may signal its location and radar sensing capabilities to the device 120 via the connection 250. Based on the location/capability information, the device 120 identifies the APD 122 and provides the mobile device 132 relevant information of the APD 122, including, for example, the position, the orientation, and configuration capabilities of the APD 122. Upon receiving the information of the APD 122, the mobile device 132 sends a message to the device 120 requesting to use the APD 122 for radar sensing. The request may include corresponding phase vectors for configuring the APD 122.

In some implementations, upon receiving the request from the mobile device 132 for using the APD 122 for radar sensing, the device 120 shares the APD's position information to the mobile device 132. In addition, the device 120 may share its own radar sensing results (e.g., regarding the obstacle 110) to the mobile device 132 as well. That is, the device 120 collaborates with the mobile device 132 to produce an object map of the environment 200 (e.g., by sharing the radar sensing results). The object map may help the mobile device 132 (or the device 120) configure the phase vectors of the APD 122 with less trials-and-errors than without having the object map.

When the device 120 allocates APD resources to the mobile device 132, the device 120 may grant direct control of the APD 122 to the mobile device 132. For example, the device 120 grants time resources and frequency resources to the mobile device 132 for transmission in the APD control channel 254. The device may also grant the mobile device 132 the time resource for APD reflection or receiving return/reflected radar sensing signals from the APD. The device 120 notifies the APD 122 with phase vectors from the mobile device 132 when either the mobile device 132 or the device 120 sends APD control (including phase vectors) on behalf of the mobile device 132 request. In some cases, the device 120 still sends grant to the mobile device 132 so that the mobile device 132 knows when to transmit radar sensing waveforms that are aligned with APD reflection configurations.

In some implementations (not shown in the environment 200 of FIG. 2), more than one mobile devices are available to the device 120 for collaborative radar sensing. Using the radar sensing techniques as discussed above, the device 120 may employ multiple mobile devices (like the mobile device 132) and multiple available APDs to perform comprehensive radar sensing to build a surrounding map of high precision (as the radar sensing assisted by mobile devices and APDs enable the device 120 to perform radar sensing behind multiple obstacles, such as the obstacles 110 and 212 in the environment 200 of FIG. 2).

FIG. 3 is a signaling diagram 300 depicting a first example method of radar sensing using APDs to overcome at least one obstacle, according to some embodiments. The signaling diagram 300 corresponds to some of the operations by the device 120, the APD 122, and the blocked object 130 discussed in FIG. 1. As shown, the device 120 performs 340 radar sensing to identify obstacle positions surrounding the device 120 (e.g., surrounding mapping). The initial radar sensing enables the device 120 to determine general positions and/or directions of the surrounding obstacles or blockers.

The device 120 has access to available APD locations, positions, orientations, capabilities, and other registered information of one or more APDs. The device 120 selects 366 an APD based on the APD positions, such that the selected APD provides a reflection of radar sensing waves from the device 120 to circumvent one or more of the surrounding obstacles. In the example shown in FIG. 1, the device 120 selects the APD 122 because the APD 122 allows the radar sensing signals 140 to travel in a reflection direction (as the APD radar sensing signals 144) behind the obstacle 110. After selecting the APD 122, the device 120 transmits 375 a control command of one or more APD phase vectors to the APD 122. The one or more APD phase vectors configure a reflection direction at the APD 122.

The device 120 then transmits 376 radar signals in a refined direction toward the APD 122 (e.g., specifically beamformed toward the APD 122 without wasting energy in dead area or the obstacle 110). According to the control command from the device 120, the APD 122 varies 377 phase vectors or other reflection configurations so as to reflect the radar sensing signals from the device 120 (in the refined direction toward the APD 122) in multiple directions (e.g., as the APD radar sensing signals 144) over time to “sweep” for the blocked object 130 behind the obstacle 110. That is, the APD 122 reflects 380 the radar signals. When the radar signals reach the blocked object 130, the blocked object 130 reflects/returns 382 a portion of the APD radar sensing signals back to the APD 122, which then reflects 384 the returned portion of the APD radar sensing signals to the device 120.

The device 120 associates the returned radar signal strength and timing with the phase vectors of the APD 122 to determine 386 the APD configuration specific to the blocked object 130. The device 120 transmits 388 the specific APD configuration to the APD 122 to configure the APD 122. The configured APD 122 establishes (390 and 392) a signal path for communications between the device 120 and the blocked object 130 as the APD 122 reflects both the radar sensing radio waves and/or the radio waves for communication signals at similar directions (e.g., joint communication and radar sensing, radar sensing alone, or communication alone).

FIG. 4 is a signaling diagram 400 depicting a second example method of radar sensing using APDs to overcome two or more obstacles (such as the obstacles 110 and 212 of FIG. 2), according to some embodiments. The signaling diagram 400 corresponds to some of the operations by the device 120, the mobile device 132 (or UE 132 as shown in FIG. 4), the APD 122, and the blocked object 130 discussed in FIG. 2.

As shown in FIG. 4, the device 120 receives 460, from the UE 132, a first message indicating the UE 132's capability of radar sensing. The device 120 receives 461 from the UE 132 a second message indicating the UE 132's ability of APD control. In some cases, the UE 132 may transmit the first message and the second message together or as a single message. In some cases, the UE 132 may include other information, such as the UE 132's location or movement status.

In response to receiving the capability information, the device 120 provides 462 APD information to the UE 132. The APD information includes multiple APDs available to the device 120 and by control transfer, available to the UE 132. Upon receiving the APD information, the UE 132 performs 440 radar sensing and detects one or more obstacles blocking the line-of-sight to areas behind the obstacles. In view of the detected obstacles, the UE 132 decides 466 to use one or more of the APDs available in view of the obstacles to further perform radar sensing behind the detected obstacles, as the blocked object 130 may be behind the obstacles.

The UE 132 sends 468 a request of radar sensing resources (for use with the APD 122) and APD control to the device 120. The device 120 then transmits 470 grants on APD resources to the UE 132. The UE 132 transmits 472 a control command to the APD 122. The UE 132 requests 474 APD phase vectors from the device 120. The device 120 transmits 476 a control command to the APD 122. For example, the control command includes an indication of control transfer to the UE 132. In some cases, the control command includes APD phase vectors for the APD 122 to reflect radar sensing waves in various directions. In some cases, instead of requesting from the device 120, the UE 132 may determine the APD phase vectors based on the APD information received at 462. The UE 132 may also directly transmit 476 control command to the APD 122 without relying on the device 120 (given proper identification and authorization from the device 120).

The UE 132, the APD 122, and the blocked object 130 operate 477 with radar sensing detection for each APD configuration (e.g., reflection direction). For example, using a first set of phase vectors, the APD 122 receives 478 a first set of radar signals from the UE 132. The UE 132 configures the beam formation of the radar sensing signals to travel in a refined direction 141 toward APD 122. The APD 122 reflects 480 the radar sensing signals toward the blocked object 130. Multiple sets of phase vectors configure the APD 122 to sweep behind obstacles blocking the line-of-sight to the UE 132.

The operations 477 continues/repeats until the APD 122 receives 482 the return of at least part of the radar sensing signals from the blocked object 130 and reflects 484 the return radar sensing signals to the UE 132. In some cases, the operations 477 repeats for the available phase vectors and the UE 132 determines 486 that the set of phase vectors corresponding to a strongest returned radar sensing signals is the proper configuration (assuming the UE 132, the APD 122, and the blocked object 130 do not move relative to each other) for the APD 122 in providing 490 and 492 a signal path between the UE 132 and the blocked object 130. If the UE 132, the APD 122, and the blocked object 130 are moving relative to each other (as movement being a property determinable by temporal changes in distances), the UE 132 may generate a set of phase vectors for the APD 122 to provide a variable signal path based on the relative movement.

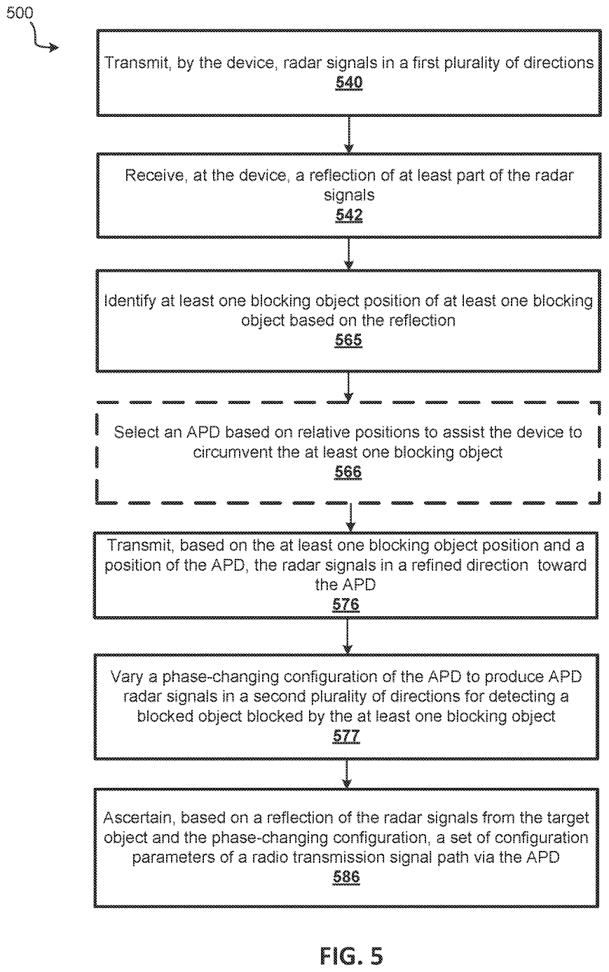

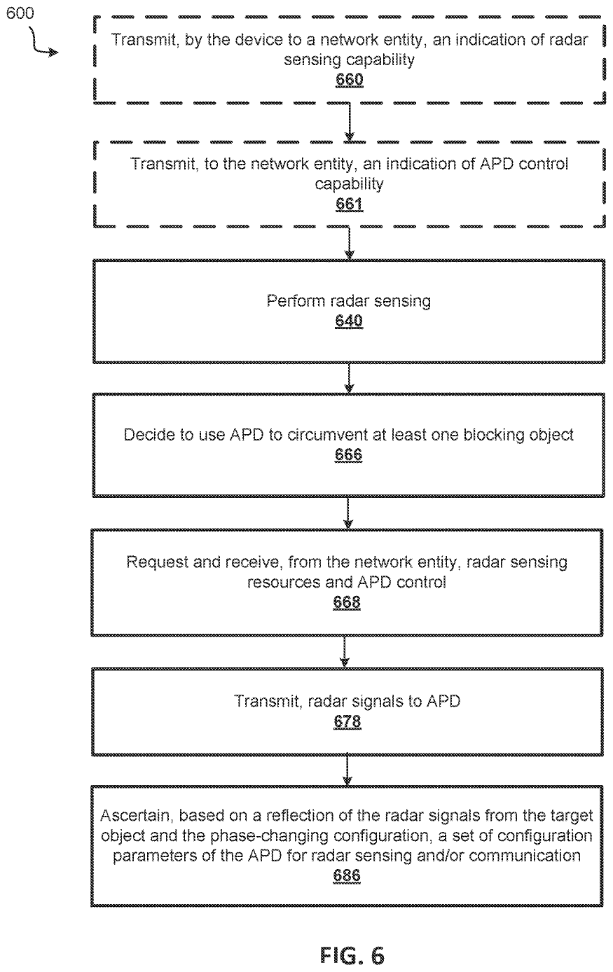

Details related to the signaling interactions illustrated in FIGS. 3 and 4 are provided below in FIGS. 5 and 6, respectively based on the perspectives of the device 120 of FIG. 1 and the mobile device 132 of FIG. 2.

FIG. 5 is a flow diagram depicting a method 500 for radar sensing using APDs, according to some embodiments. A wireless device, such as a base station or a UE (e.g., the device 120 of FIGS. 1-4), may perform the method 500.

As shown in FIG. 5, the method 500 starts as the wireless device transmits 540 radar signals in a first plurality of directions (e.g., part of operation 340 of FIG. 3). The wireless device then receives 542 a reflection of at least part of the radar signals (e.g., from an obstacle) (e.g., operation 142 of FIG. 1). The wireless device identifies 565 at least one blocking object position of at least one blocking object based on the reflection (e.g., part of operation 340 of FIG. 3). For example, the wireless device performs radar sensing to obtain a coarse map of obstacles of its surroundings, such as the device 120 identifying the obstacle 110 using the radar sensing signals 140 in FIG. 1. In some cases, instead of or in addition to performing radar sensing, the wireless device receives a map that provides locations and blocking coverage of the at least one blocking object.

The wireless device then selects 566 an APD based on relative positions to assist the device to circumvent the at least one blocking object (e.g., operation 366 of FIG. 3). In some implementations, the wireless device further selects, based on the at least one blocking object position and respective positions of a plurality of deployed APDs, the APD from the plurality of deployed APDs so that the radar signals in the refined direction reaches the APD; and the radar signals in the second plurality of directions reflected by the APD reaches behind the at least one blocking object. In some cases, the wireless device receives or has received registrations of the respective positions and directions of the plurality of deployed APDs. In some cases, one or more of the plurality of deployed APDs may move and provide corresponding position updates to the device in the registrations.

The wireless device transmits 576, based on the at least one blocking object position and a position of the APD, the radar signals in a refined direction toward the APD (such as the radar signals 376 of FIG. 3, or in view the radar signals 141 of FIG. 1). For example, the refined direction may result from beamforming at the wireless device to avoid unnecessary energy loss in other directions (e.g., toward the blocking object or in a direction that does not reach the APD).

The method 500 continues as the wireless device applies/varies 577 a phase-changing configuration (e.g., multiple phase vectors applying to the APD over time) of the APD to produce APD radar signals in a second plurality of directions for detecting a blocked object (such as the operation 377 of FIG. 3). For example, the wireless device varies 577 the phase-changing configuration of the APD to produce the APD radar signals by transmitting various sets of configuration parameters, corresponding to a plurality of phases of the APD, to produce the APD radar signals in the second plurality of directions based on one or more of: a fixed location of a network entity, the at least one blocking object position, or the position of the APD.

In some cases, the wireless device may transmit the various sets of configuration parameters by completing a detection operation for each set of configuration parameters before transmitting a next set of configuration parameters. For example, completing the detection operation may include detecting an expiration of a timer based on a radar sensing range, or detecting, at a receiver, the reflection of the radar signals from the object. In some cases, the wireless device may provide a complete APD control command that includes multiple sets of phase vectors to apply at the APD over a period of time (e.g., sweeping at various directions at pre-defined time intervals). The wireless device repeats/varies 577 the phase-changing configuration of the APD when detecting a reflection of the APD radar signals or upon an expiration of a timer without detecting a reflection.

The wireless device ascertains 586, based on a reflection of the radar signals from the blocked object and the phase-changing configuration, a set of configuration parameters for a radio transmission signal path via the APD towards the blocked object (e.g., operation 386 of FIG. 3).

In some implementations, the wireless device may establish a wireless connection with the object (such as the mobile device 132 of FIG. 2) behind the at least one blocking object. The wireless device may grant control of the APD to the object. In some cases, given access to the APD, the object may perform operations similar to those performed by the wireless device, as discussed in FIG. 2. For example, the wireless device includes a UE device (e.g., the mobile device 132 in FIG. 2). The wireless device transmits, to a network entity (e.g., the device 120 in FIG. 2) having initial control of the APD (e.g., the APD 122 in FIG. 2), a message (e.g., 450 and 451 of FIG. 4) indicating a radar sensing capability of the UE device or results of radar sensing performed by the UE device. The UE device receives, from the network entity, information of the APD, and requests control of the APD from the network entity.

When a blocked object is surrounded by two or more obstacles, the wireless device (e.g., the device 120 of FIG. 2) may employ assistance from a UE device (e.g., the mobile device 132). For example, the wireless device of FIG. 5 may employ another device to perform operations similar to operations 566, 576, 577, and 586. The wireless device may use the UE device for radar sensing and/or communicating with the blocked object if the wireless device itself cannot use available APDs to reach the blocked object while the UE device can (such as the example shown in FIG. 2). The following discusses example operations for the wireless device being a UE device (e.g., the mobile device 132).

FIG. 6 is a flow diagram depicting a method 600 by a UE device in communication with a network entity for radar sensing using APDs, according to some embodiments. A UE device (e.g., the UE 132 of FIGS. 2 and 4), may perform the method 600,

As shown in FIG. 6, the method 600 starts as the UE device optionally transmits 660 to the network entity an indication of radar sensing capability (e.g., operation 460 of FIG. 4). In some embodiments, the UE device also transmits 661 an indication of APD control capability (e.g., operation 461 of FIG. 4). In other examples, the UE device's capability on radar sensing and/or APD control may have otherwise been available to the network entity (e.g., pre-registered).

The method 600 continues as the UE device performs 640 radar sensing (e.g., operation 440 of FIG. 4). For example, the network entity may seek help from UE devices capable of radar sensing and/or APD control to seek blocked objects that the network entity cannot reach, even with access to APDs (e.g., the device 120 of FIG. 2). The network entity may then ask connected UE devices to perform radar sensing. If the UE device does not detect any blocking object, the UE device may be in line-of-sight with an object not reachable by the network entity.

If the UE device detects at least one blocking object, the UE device decides 666 to use APDs available to the network device (and applicable to the UE device in the circumstances) to circumvent the at least one blocking object (e.g., operation 466 of FIG. 4). For example, the wireless device reports, to the network entity, the at least one blocking object position. The at least one blocking object position allows the network entity to identify (e.g., based on multiple APDs registered at the network entity) one or more APDs that may assist the wireless device in routing communication signals around the at least one blocking object. The UE device receives, from the network entity in response to the reporting, an indication of one or more available APDs and respective positions thereof.

The UE device then requests 668 and receives, from the network entity, radar sensing resources and APD control of one of the available APDs capable of reflecting radar signals based on the respective positions (e.g., operation 468 of FIG. 4). In some cases, the network entity may select or identify the APD in the place of the wireless device, as the network entity may have greater computational resources and information about the APDs than the wireless device.

The UE device then transmits 678 (e.g., using a monostatic radar) the radar signals in the first plurality of directions and the refined direction toward the APD (e.g., operation 478 of FIG. 4). The APD reflects, based on phase vectors configured by the wireless device, the radar sensing signals around the at least one blocking object. The monostatic radar of the wireless device receives the reflection of at least part of the radar signals and the reflection of the APD radar signals. The monostatic radar is configured to operate a common set of transmitter and receiver for network communications.

In some implementations, the APD control command varies a phase-changing configuration of the APD by causing a change of a phase of an antenna of the APD to produce the APD radar signals in the second plurality of directions over time (e.g., multiple set of phase vectors for multiple directions). In some cases, the changing the phase of the antenna element of the APD to produce the APD radar signals in the second plurality of directions includes passively altering directional characteristics of the APD or actively altering the directional characteristics and amplitude characteristics of the APD.

The UE device ascertains 686, based on a reflection of the radar signals from the target object and the phase-changing configuration, a set of configuration parameters of the APD for radar sensing and/or communication (e.g., operation 486 of FIG. 4).

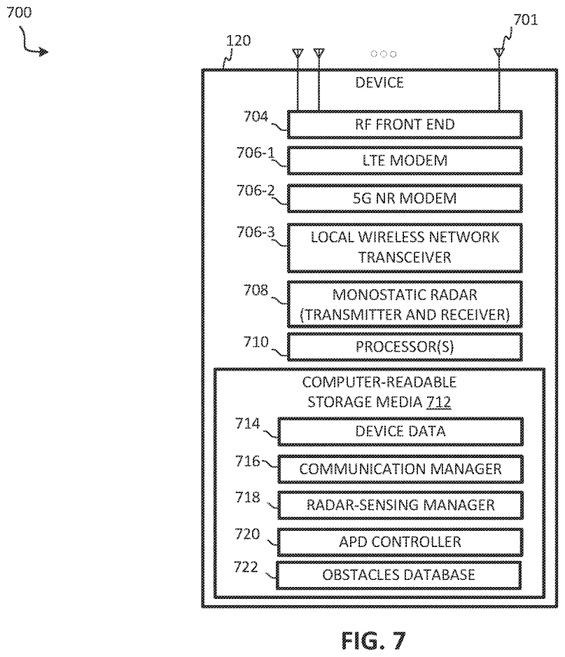

The methods 500 and 600 of FIGS. 5 and 6 may be performed by a device having components or hardware resources as illustrated in FIG. 7.

FIG. 7 is a block diagram depicting an example device diagram 700 of a device (e.g., the device 120, a base station, a UE, a blocked object 130, or the mobile device 132), according to some embodiments. The device diagram 700 describes a device that can implement various aspects of radar sensing with assistance from APDs. The device 120 may include additional functions and interfaces that are omitted from FIG. 7 for the sake of clarity.

The device 120 includes antennas 701, a radio frequency (RF) front end 704, and one or more RF transceivers 706 (e.g., a 3GPP Fourth Generation (4G) Long Term Evolution (LTE) transceiver 706-1 and a 5G NR transceiver 706-2) for communicating with a base station, such as a 5G RAN and/or an E-UTRAN. One antenna array may be used for cellular signaling and (optionally) another antenna array may be used for wireless communication across a sidelink connection.

The device 120 includes one or more additional transceivers 706-3, such as a local wireless network transceiver, for communicating over one or more local wireless networks (e.g., WLAN, Bluetooth, Near-Field Communication (NFC), a personal area network (PAN), Wireless Fidelity Direct (Wi-Fi-Direct), IEEE 702.15.4, ZigBee, Thread, mm Wave, and the like) with other UE devices (e.g., the mobile device 132), such as those in a wirelessly tethered configuration with the device 120. The RF front end 704 couples or connects the LTE transceiver 706-1, the 5G NR transceiver 706-2, and the local wireless network transceiver 706-3 to the antennas 701 to facilitate various types of wireless communication.

The antennas 701 of the device 120 include an array of multiple antennas configured similar to or different from each other. The antennas 701 and the RF front end 704 are tuned to, and/or can be tunable to, one or more frequency bands, such as those defined by the 3GPP 4G LTE, 3GPP 5G NR, IEEE wireless metropolitan access network (WMAN), or other communication standards. The antennas 701, the RF front end 704, the LTE transceiver 706-1, the 5G NR transceiver 706-2, and/or the local wireless network transceiver 706-3 are configured to support beamforming (e.g., analog, digital, or hybrid), or in-phase and quadrature (I/Q) operations (e.g., I/Q modulation or demodulation operations) for the transmission and reception of communications with the base station. By way of example, the antennas 701 and the RF front end 704 operate in sub-gigahertz bands, sub-7 GHz bands, and/or above 7 GHz bands defined by the 3GPP LTE, 3GPP 5G NR, or other communication standards.

Using at least a portion of the antennas 701, the device 120 can form beams that are steered or un-steered, wide or narrow, or shaped (e.g., as a hemisphere, cube, fan, cone, or cylinder). The one or more transmitting antennas may have an un-steered omnidirectional radiation pattern or may be able to produce a wide steerable beam.

The device 120 includes a monostatic radar 708, which includes at least a transmitter and a receiver. The transmitter and the receiver are shared for both radar sensing and control/data signaling operations (e.g., may use the antennas 701). The monostatic radar 708 may use time-of-flight principles or frequency modulated continuous-wave (FMCW) principles to measure properties (e.g., distance, direction, movement, size, etc.) of an object based on returned radar sensing signals from the object.

The device 120 may include one or more sensors (not shown) implemented to detect various properties such as temperature, supplied power, power usage, battery state, or the like. The sensors can include any one or a combination of temperature sensors, thermistors, battery sensors, and power usage sensors. The device 120 uses the various properties to determine whether the device 120 has the capability to connect to the cellular network over its air interface, or if the device 120 only has enough resources (e.g., battery power, etc.) to connect to the cellular network using a sidelink connection to another UE device.

The device 120 also includes at least one processor 710 and a non-transitory computer-readable storage media 712 (CRM 712). The computer-readable storage media described herein excludes propagating signals. The CRM 712 includes any suitable memory or storage device such as random-access memory (RAM), static RAM (SRAM), dynamic RAM (DRAM), non-volatile RAM (NVRAM), read-only memory (ROM), or Flash memory useable to store device data 714 of the device 120. The device data 714 includes, for example, user data, multimedia data, beamforming codebooks, applications, and/or an operating system of the device 120, which are executable by the processor 710 to enable user-plane communication, control-plane signaling, and user interaction with the device 120.

The CRM 712 includes a communication manager 716. Alternatively, or additionally, the communication manager 716 is implemented in whole or part as hardware logic or circuitry integrated with or separate from other components of the device 120. The communication manager 716 configures the RF front end 704, the LTE transceiver 706-1, the 5G NR transceiver 706-2, and/or the local wireless network transceiver 706-3 to perform one or more wireless communication operations.

The CRM 712 further includes a radar sensing manager 718, an APD controller 720, and an obstacles database 722. The radar sensing manager 718 and the APD controller 720 allow the device 120 to configure and/or control APDs to route around obstacle blocking line-of-sight radar sensing. For example, the radar sensing manager 718 manages coarse mapping of obstacles in the surroundings of the device 120 (without using APDs) and saves the detected obstacles in the obstacles database 722. The device 120 may store APD information in a memory device of the computer-readable storage media 712 and identify one or more APDs that provide a reflective path to route around the currently detected obstacles. The APD controller 720 generates multiple sets of phase vectors for controlling the one or more APDs to vary reflective directions to sweep multiple directional radar sensing beams behind the one or more obstacles, and enables the monostatic radar 708 and the processor(s) 710 to identify blocked objects behind the one or more obstacles. In some embodiments, one or more of these components, in at least some embodiments, are implemented in whole or part as hardware logic or circuitry integrated with or separate from other components of the device 120.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may include a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above. For example, the method 700 may be performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1-16. (canceled)

17. A method of identifying radio transmission signal paths by a device in control of an adaptive phase-changing device (APD), the method comprising:
transmitting, by the device, radar signals in a first plurality of directions;
receiving, at the device, a reflection of at least part of the radar signals;
identifying at least one blocking object position of at least one blocking object based on the reflection;
transmitting, based on the at least one blocking object position and a position of the APD, the radar signals in a refined direction toward the APD;
varying a phase-changing configuration of the APD to produce APD radar signals in a second plurality of directions for detecting an object; and
ascertaining, based on a reflection of the APD radar signals from the object and the phase-changing configuration, a set of configuration parameters of a radio transmission signal path via the APD.

18. The method of claim 17, further comprising:
selecting, by the device, based on the at least one blocking object position and respective positions of a plurality of deployed APDs, the APD from the plurality of deployed APDs, wherein:
the radar signals in the refined direction reaches the APD; and
the APD radar signals in the second plurality of directions reaches behind the at least
one blocking object.

19. The method of claim 18, wherein the selecting further comprises:
receiving registrations of the respective positions of the plurality of deployed APDs, wherein one or more of the plurality of deployed APDs move and provide corresponding position updates to the device in the registrations.

20. The method of claim 17, wherein the varying the phase-changing configuration of the APD to produce the APD radar signals comprises:
transmitting various sets of configuration parameters, corresponding to a plurality of phases of the APD, based on one or more of:
a fixed location of a network entity,
the at least one blocking object position, or
the position of the APD.

21. The method of claim 20, wherein the transmitting the various sets of configuration parameters comprises:
completing a detection operation for each set of configuration parameters before transmitting a next set of configuration parameters, wherein completing the detection operation comprises:
detecting, by the device, an expiration of a timer based on a radar sensing range; or
detecting, by the device at a receiver, the reflection of the APD radar signals from the object.

22. The method of claim 21, further comprising:
establishing a wireless connection with the object behind the at least one blocking object; and
granting control of the APD to the object.

23. The method of claim 17, further comprising:
transmitting, by the device as a user equipment (UE) device, to a network entity in initial control of the APD, a message indicating a radar sensing capability of the UE device or results of radar sensing performed by the UE device;
receiving, from the network entity, information of the APD ; and
requesting, from the network entity, control of the APD.

24. The method of claim 23, wherein requesting, from the network entity, the control of the APD comprises:
transmitting, to the network entity, a request to perform radar sensing at the network entity to detect the object behind the at least one blocking object identified by the device; and
receiving, from the network entity, an indication of failing to detect the object.

25. The method of claim 24, wherein:
the receiving information of the APD comprises:
reporting, to the network entity, the at least one blocking object position; and
receiving, from the network entity in response to the reporting, an indication of one or more available APDs and respective positions thereof; and
the requesting control of the APD comprises:
selecting one of the one or more available APDs as the APD.

26. The method of claim 17, wherein the varying the phase-changing configuration of the APD comprises:
changing a phase of an antenna element of the APD to produce the APD radar signals in the second plurality of directions.

27. The method of claim 26, wherein changing the phase of the antenna element of the APD to produce the APD radar signals in the second plurality of directions comprises:
passively altering directional characteristics of the APD; or
actively altering the directional characteristics and amplitude characteristics of the APD.

28. A user equipment (UE), comprising:
one or more radio frequency (RF) modems;
a processor coupled to the one or more RF modems; and
at least one memory storing executable instructions, the executable instructions to manipulate at least one of the processor or the one or more RF modems to:
transmit, by the UE, radar signals in a first plurality of directions;
receive, at the UE, a reflection of at least part of the radar signals;
identify at least one blocking object position of at least one blocking object based on the reflection;
transmit, based on the at least one blocking object position and a position of an adaptive phase-changing device (APD), the radar signals in a refined direction toward the APD;
vary a phase-changing configuration of the APD to produce APD radar signals in a second plurality of directions for detecting an object; and
ascertain, based on a reflection of the APD radar signals from the object and the phase-changing configuration, a set of configuration parameters of a radio transmission signal path via the APD.

29. The UE of claim 28, further comprising a monostatic radar configured to:
transmit the radar signals in the first plurality of directions and the refined direction, and
receive the reflection of at least part of the radar signals and the reflection of the APD radar signals, wherein the monostatic radar is configured to operate a common set of transmitter and receiver for network communications.

30. A network entity, comprising:
one or more radio frequency (RF), modems;
a processor coupled to the one or more RF modems; and
at least one memory storing executable instructions, the executable instructions to manipulate at least one of the processor or the one or more RF modems to:
transmit, by the network entity, radar signals in a first plurality of directions;
receive, at the network entity, a reflection of at least part of the radar signals;
identify at least one blocking object position of at least one blocking object based on the reflection;
transmit, based on the at least one blocking object position and a position of an adaptive phase-changing device (APD), the radar signals in a refined direction toward the APD;
vary a phase-changing configuration of the APD to produce APD radar signals in a second plurality of directions for detecting an object; and
ascertain, based on a reflection of the APD radar signals from the object and the phase-changing configuration, a set of configuration parameters of a radio transmission signal path via the APD.

31. The network entity of claim 30, wherein the processor is further configured to:
select, by the device, based on the at least one blocking object position and respective positions of a plurality of deployed adaptive phase-changing devices (APDs), the APD from the plurality of deployed APDs, wherein:
the radar signals in the refined direction reaches the APD; and
the APD radar signals in the second plurality of directions reaches behind the at least
one blocking object.

32. The network entity of claim 31, wherein the selecting further comprises:
receiving registrations of the respective positions of the plurality of deployed APDs, wherein one or more of the plurality of deployed APDs move and provide corresponding position updates to the device in the registrations.

33. The network entity of claim 30, wherein the varying the phase-changing configuration of the APD to produce the APD radar signals comprises:
transmitting various sets of configuration parameters, corresponding to a plurality of phases of the APD, based on one or more of:
a fixed location of the network entity,
the at least one blocking object position, or
the position of the APD.

34. The network entity of claim 33, wherein the transmitting the various sets of configuration parameters comprises:
completing a detection operation for each set of configuration parameters before transmitting a next set of configuration parameters, wherein completing the detection operation comprises:
detecting, by the device, an expiration of a timer based on a radar sensing range; or
detecting, by the device at a receiver, the reflection of the APD radar signals from the object.

35. The network entity of claim 34, wherein the processor is further configured to:
establish a wireless connection with the object behind the at least one blocking object; and
grant control of the APD to the object.

36. The network entity of claim 30, wherein the processor is further configured to:
transmit, by the device as a user equipment (UE) device, to a network entity in initial control of the APD, a message indicating a radar sensing capability of the UE device or results of radar sensing performed by the UE device;
receive, from the network entity, information of the APD ; and
request, from the network entity, control of the APD.
